(19) United States
(12) Patent Application Publication
(10) Pub. No.: US 2010/0016107 A1
(43) Pub. Date: Jan. 21, 2010

(54) SPROCKET FOR CHAIN DRIVES

(76) Inventors: Adam Klabisch, Dortmund (DE); Gerhard Merten, Lunen (DE); Diedrich Bettermann, Unna (DE)

Correspondence Address: FAY SHARPE LLP, 1228 Euclid Avenue, 5th Floor, The Halle Building, Cleveland, OH, 44115, US

(21) Appl. No.: 12/525,709

(22) PCT Filed: Jan. 8, 2008
(86) PCT No.: PCT/EP2008/000068

§ 371 Date: Sep. 29, 2009

(30) Foreign Application Priority Data
Feb. 8, 2007 (DE) 20 2007 002 119.4

(51) Int. Cl. F16H 55/30

(52) U.S. Cl. 474/155

(57) ABSTRACT

The invention relates to a sprocket for chain drives, with an axis of rotation and with two groups, arranged next to and offset with respect to one another on the circumference of the sprocket, of pockets for chain links passing the sprocket in an oblique position. Each pocket is delimited laterally by a side wall and an opposite wall and, in the circumferential direction, by webs. In order that a sprocket for chain links running in obliquely can be produced more simply and to provide a better distribution of forces, according to the invention the side wall and the opposite wall of a pocket form for the chain links bearing surfaces which run obliquely with respect to the axis of rotation and which extend as far as a bottom of the pockets.

This application claims priority to and the benefit of the filing date of International Application No. PCT/EP2008/000068, filed Jan. 8, 2008, which application claims priority to and the benefit of the filing date of German Application No. 20 2007 002 119.4, filed Feb. 8, 2007, both of which are hereby incorporated by reference into the specification of this application.

### BACKGROUND

The invention relates to a sprocket for chain drives, with an axis of rotation and with two groups, arranged next to and offset with respect to one another on the circumference of the sprocket, of pockets for chain links passing the sprocket in an oblique position in relation to the sprocket axis, each pocket being delimited laterally by a side wall and an opposite wall and, in the circumferential direction, by webs which form, with flank portions, a front wall and rear wall of the pockets of one group for the transmission of forces to a chain link rotating in the pocket and which form with a side portion the side wall of the pockets of the other group.

One example of a known sprocket is exemplified in DE 10 2004 009 535 A1. The known sprocket is designed and rated for chain drives of hoists and elevators and on each side flank of the sprocket has in each case five webs, consequently five pockets per group. Each group of pockets forms a pocket row, the pockets of which are separated from one another by means of the teeth, the flank portions of the teeth running parallel to the axis of rotation of the sprocket, with the exception of transitional zones on the inner faces of the side flanks, while the side wall and the respective opposite wall are oriented perpendicularly to the axis of rotation. One link leg of a chain link then lies on a pocket bottom which extends essentially parallel to the sprocket axis and which lies nearer to the axis of rotation, while the other leg of the chain link lies on the upper end faces of the teeth and comes to bear laterally against an inner face of the flanks. The distance between the side wall and the opposite wall is dimensioned such that a chain link rotating in the pocket can move transversely with respect to the axis of rotation, in order to prevent the occurrence of critical stresses. To manufacture the sprocket, two sprocket halves designed identically to one another have to be produced and are subsequently connected to one another releasably or unreleasably.

A further sprocket into which chain links of a link chain can run obliquely is known from DE 297 13 055 U1. In this sprocket, four webs are provided on each side flank for producing in each case four pockets per pocket row. The bearing surface, located nearer to the axis of the sprocket, for the one link leg of the chain links is designed as a pocket bottom which runs obliquely with respect to the axis of rotation and which merges via a free surface, running parallel to the axis of rotation or sprocket axis, into a step which is formed by the web for the chain links of the other pocket. The opposite longitudinal leg of the same chain link is supported on the web roof surface which is oriented parallel to the sprocket axis and which is provided with a depression or groove for receiving a weld bead on the longitudinal legs of the chain links. Each web is designed in such a way that it projects beyond the mid-plane of the sprocket designed symmetrically to this and therefore projects into the pocket of the other pocket group in each case. This known sprocket, too, is intended solely for hoists.

In chain drives used in underground mining, chain starwheels or sprockets are used which have pockets for the reception of chain links lying horizontally during operational use, while the connecting links pass as vertical chain links through interspaces between the teeth or stars of the sprocket and rotate on the sprocket essentially without the transmission of circumferential forces. Depending on the configuration of the chain starwheels or of the chain drives provided with the chain starwheels, the sprockets may be provided with one pocket row or with two pocket rows, lying next to one another, for double chain drives.

### SUMMARY OF THE INVENTION

One object of the invention is to provide a sprocket for chain links running obliquely into the sprocket, which can be produced more simply than the known sprockets and allows a better distribution of forces to the carrying chain links rotating in the pockets. The abovementioned object is achieved, according to the invention, in a sprocket, in that the side wall and the opposite wall of a pocket in each case form for the chain links bearing surfaces which run obliquely with respect to the axis of rotation, the oblique bearing surfaces extending as far as a bottom portion of the pocket. In contrast to the sprockets according to the prior art, for chain links running in obliquely, in which at least some portions of the pockets are parallel or perpendicular to the axis of rotation or sprocket axis, in the sprocket according to the invention the bearing surfaces lie as far as possible completely obliquely with respect to the axis of rotation. The angular opening, thus resulting in a cross section, of each pocket of the sprocket can be produced at low outlay and can be adapted in a relatively simple way to different geometries and cross sections of the chain links, at the same time ensuring that the transmission of forces in the circumferential direction is assumed solely by the flanked portions of the two webs delimiting each pocket. In each case the upper or outer leg of each chain link thus comes to bear laterally against the side portion of that web which with its flank portions forms the front and the rear wall of the pockets in each case of the other pocket row lying offset. Portions of the webs which in the prior art engage into the inner orifices of the chain links bearing laterally against the web may essentially or completely be dispensed with.

In a preferred embodiment, the bearing surface on the side portion of the webs is designed as a planar surface extending as far as the bottom portion of the pocket. Such a bearing surface or surface of the side portions of the webs can be provided or produced relatively simply, in particular can be manufactured, for example milled, in one operation. The bottom portion of the pocket in this case preferably consists of an angular transition of the side wall formed by the web of the pockets of one group into the opposite wall lying in each case opposite the web. The bottom portion may, particularly at the transition, be provided with a preferably rounded longitudinal channel, said longitudinal channel forming a free surface for the circumferential zones of the legs of the chain links. It is particularly advantageous if the transitions or longitudinal channels of one group of pockets and the transitions or longitudinal channels of the other group of pockets lie offset with respect to a mid-plane of the sprocket. By virtue of this configuration, the sprocket width required overall and therefore also the overall weight of a corresponding sprocket can advantageously be reduced.

In another preferred embodiment, the bearing surface on the side wall and the bearing surface on the opposite wall stand obliquely to the axis of rotation and at the same time at right angles to one another. A pocket with bearing surfaces, standing at right angles to one another, for the chain links can not only be produced particularly simply, but at the same time ensures a beneficial support of the chain links received in the pockets. In a most favorable instance, the respective chain links standing obliquely then run into the sprocket and out of the sprocket at an angle of 45°, so that successive chain links are also supported in their optimal 45° orientation on the bearing surfaces in the pockets lying laterally and offset with respect to one another in the circumferential direction and at the same time are acted upon by the circumferential forces in the circumferential direction by means of the flank portions of the webs. In this case, it proves to be particularly advantageous that each chain link rotating in the pockets of the sprocket forms a carrying chain link which absorbs the circumferential forces which are to be introduced from the drive of the sprocket into the link chain. This gives rise, particularly also in comparison with the conventional configuration of chain links with horizontal carrying chain links and with vertical non-carrying chain links, to the particular advantage that a substantially more beneficial distribution of forces to the individual rotating chain links occurs, the polygonal effect is minimized and substantially lower speed differences arise during rotation on account of the polygonal effect than was the case in the conventional sprockets or chain starwheels known in the prior art.

The geometry, simplified according to one aspect of the invention, of the pocket cross sections with bearing surfaces, running obliquely with respect to one another, on the side wall and on the opposite wall makes it possible that the sprocket can preferably be produced from or consist of a one-part blank or cast blank with preferably preformed pockets, if appropriate only the final form of the pockets being generated by means of milling methods and/or grinding methods, and the surfaces occurring then acquiring wear protection, if appropriate, by means of hardening, annealing or the like. The simple pocket geometry, particularly with pocket bearing surfaces standing at right angles to one another and inclined at an angle of 45°, makes it possible that the sprocket can then be finish-machined in a fixture by means of relatively simple machining tools and the pockets can acquire their desired geometry, including suitable roundings on the flank portions of the webs, in order to ensure a favorable run of the chain links into the sprocket and, during rotation, to achieve lower loads on the chain links lying in the pockets. As a result, at the same time, vibrations which are introduced from the sprocket into the link chain and may lead to additional loads on the link chains or drive units, particularly when the link chains are rotating, also decrease.

Expediently, the sprocket has two side flanks, each side flank being provided with a number of webs which corresponds to the number of pockets, and an opposite wall being formed between two webs of a side flank. In the particularly preferred embodiment of a sprocket according to the invention, the bearing surface of the opposite wall has a lower radial height than the bearing surface on the web. A chain link is supported with the outside of the oblique cross or of a leg of the chain links on the bearing surface of the opposite wall, while the chain link bears with its underside, essentially over a large area, against the bearing surface on the web, consequently against the side wall of a pocket.

Particularly for the use of the sprockets according to the invention in mining, such as, for example, mineral extraction (salt, potash or the like) or coal extraction, it is particularly advantageous if each opposite wall is provided with at least one displacement orifice for fine coal, salts, rock or mineral accumulations or the like. According to an advantageous embodiment, the displacement orifices or expelling orifices consist of a passage in the opposite wall if, for example, the sprocket has on both side flanks a peripheral closed margin or collar. It is particularly advantageous, however, if the webs are formed on tooth-shaped elevations on the two side flanks of the sprocket, and, between the elevations, sinks are provided which at least partially form the displacement orifices for fine coal, dust, salts or the like. The combination of elevations and sinks with passages in the opposite wall may also afford particular advantages. Instead of passages in the opposite wall, the sinks could also be formed between the tooth-shaped elevations in such a way that they extend, at least in the middle of the pockets, as far as the pocket bottom, so that the individual pockets are consequently designed as “deep-drawn” pockets and are open toward the side flank in the region of the opposite wall. The cross section of these sinks forming the displacement orifices may, in turn, have approximately V-shaped profile, in order by means of the deep sinks to achieve large displacement orifices between tooth-shaped elevations which at the same time are of robust design. In order to improve the displacement or discharge of accumulations of fine coal or the like, which, in particular, are also inclined to briquetting and may thereby considerably impair the run-in behavior of the chain links into the pockets of the sprocket, the side flanks may be provided with discharge slopes in the region of the passages or of the sinks extending to a great depth. The passages in the side flanks below the sinks may preferably consist of long holes. Both the configuration with sinks extending to a great depth and the configuration with long holes in the region of the opposite wall have the advantage that, when the chain link runs into the pocket, smaller rock fragments or briquetting could be pushed downward when a chain link runs into the pockets and could then be pressed away outward through the displacement orifices. According to an advantageous embodiment, each side flank may be provided in each case with 4 to 8 elevations and sinks, in particular with six elevations and six sinks, which are in each case spaced apart at 60° from one another, so that the sprocket overall has twelve pockets, of which in each case six pockets form a pocket row or pocket group.

The preferred field of use of a sprocket according to the invention with pockets which have lateral bearing surfaces, standing obliquely with respect to one another, with the chain links running in at an angle of 45° is as a driving or deflecting sprocket for the planing chain of a mining plane for mineral or coal extraction or for the scraper chain of a scraper chain conveyor for mineral extraction, coal extraction or mining. When the sprockets with pockets are used for chain links running obliquely, because all the chain links, as carrying chain links, transmit the circumferential forces introduced by means of the drive to the link chain, the loads on the chain links when they rotate in the pockets of the sprocket are reduced. This gives rise to markedly more beneficial distributions of forces to the carrying chain links, and the wear of the chain links when they rotate about the sprocket falls, while at the same time vibrations introduced into the rotating chain are reduced. In scraper chain conveyors, there is the further advantage that the chain can be drawn in this 45° oblique position through the trough sections of the scraper chain conveyor or can run through the trough sections, the oblique position of the chain links of the chain making it possible to have a lower overall height both of the conveying strand and of the return strand for the scraper chain. Since, in a link chain with chain links running obliquely, both chain links are supported on the bottom of the conveying strand and return strand, the wear on the conveyor bottom or on the bottom of the lower strand decreases at the same time. The system technology involved in the use of sprockets with pockets for chain links entering the sprocket obliquely can therefore, overall, improve the useful life of scraper chain conveyors and of underground mining installations.

These and other objects, aspects, features and advantages of the invention will become apparent to those skilled in the art upon a reading of the Detailed Description of embodiments set forth below taken together with the drawings which will be described in the next section.

### BRIEF DESCRIPTION OF THE DRAWINGS

The invention may take physical form in certain parts and arrangement of parts, a preferred embodiment of which will be described in detail and illustrated in the accompanying drawings which form a part hereof and wherein:

FIG. 1 shows diagrammatically a sprocket according to the invention in the first exemplary embodiment in a side view;

FIG. 2 shows a sectional view along II-II in FIG. 1;

FIG. 3 shows a sectional view along III-III in FIG. 1;

FIG. 4 shows a view along the arrow IV in FIG. 2;

FIG. 5 shows a sprocket according to the invention in a second exemplary embodiment in a side view;

FIG. 6 shows a sectional view along VI-VI in FIG. 5;

FIG. 7 shows a sectional view along VII-VII in FIG. 5;

FIG. 8 shows a top view of a pocket of the sprocket according to the arrow VIII in FIG. 6;

FIG. 9 shows a sprocket according to the invention in a third exemplary embodiment in a side view;

FIG. 10 shows a sectional view along X-X in FIG. 9;

FIG. 11 shows a sectional view along XI-XI in FIG. 9;

FIG. 12 shows a view along the arrow XII in FIG. 10; and

FIG. 13 shows diagrammatically, and greatly simplified, a scraper chain conveyor with a scraper chain band having chain links lying obliquely, in a vertical section through a conveyor section.

### DETAILED DESCRIPTION OF EMBODIMENTS

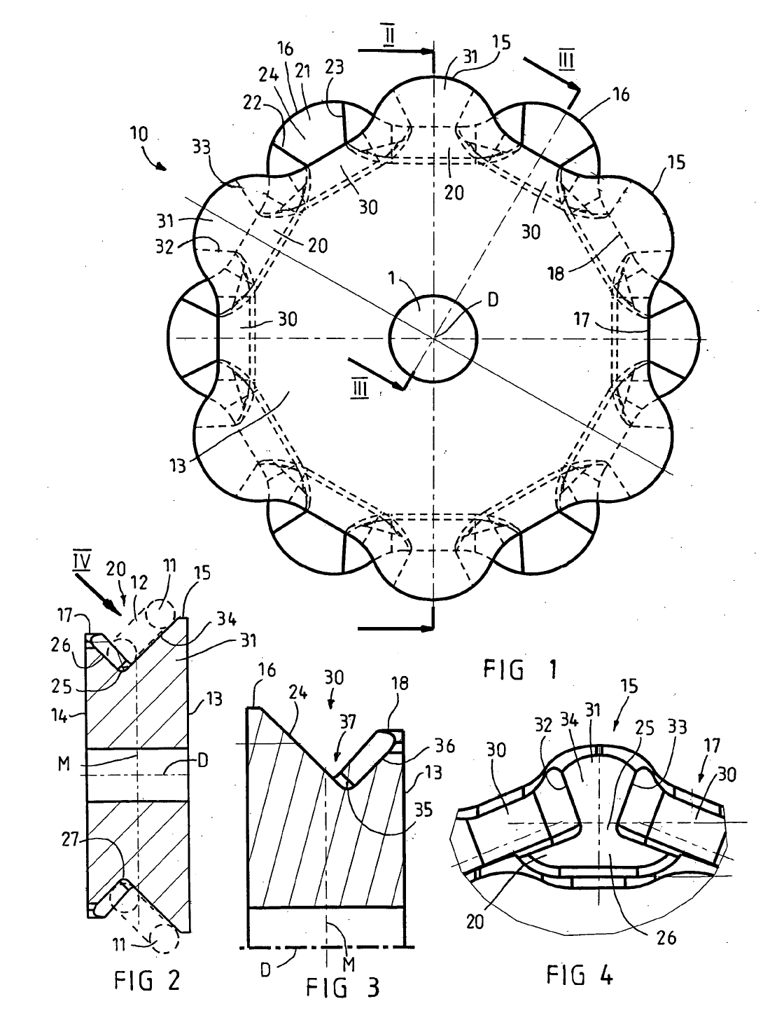

Referring now to the drawings wherein the showings are for the purpose of illustrating preferred and alternative embodiments of the invention only and not for the purpose of limiting same, FIG. 1 illustrates a sprocket 10 for the drive or deflection of scraper chains of the scraper chain conveyor or planing chains of a mining plane drawn by means of chains. The sprocket 10 is produced from a preferably one-part cast blank and has an axis of rotation D at the center of a shaft receptacle 1 for the output shaft of a drive or deflection station, not illustrated. The sprocket 10 is provided, distributed at uniform angular intervals on the circumference, with two rows or groups of pockets 20 and 30 lying next to one another, in each case two pockets 20 of one pocket row and two pockets 30 of the other pocket row lying offset with respect to one another at 60°. Both the pockets 20 and the pockets 30 are designed such that the sprocket 10 can receive obliquely passing chain links of a chain link chain and can deflect them over essentially 180° from chain run-in to chain run-out. For this purpose, the pockets 20 are arranged offset with respect to the pockets 30 not only in the circumferential direction, but also transversely to the axis of rotation, with the result that, as indicated by the chain link 11, illustrated by dashes in FIG. 2, in the pocket 20, the obliquely running chain links are in each case received, coming to bear laterally, in the pockets 20 and 30 on the sprocket 10 and, when the sprockets are driven, can be acted upon with forces in the circumferential direction.

The chain links 11, which preferably consist of oval round chain links of suitable wire cross section, in particular a round wire cross section, and which engage alternately into the oval eye 12 on the following chain link, thus coming to lie, depending on their oblique position, either in the pocket 20 or in the pocket 30 during a rotation of the sprocket 10. So that forces can be transmitted in the circumferential direction by means of the sprocket 10 to the chain links located in the pockets 20 and 30, there are formed on the two side flanks 13 and 14 of the sprocket 10 which determine the width of the sprocket 10, webs 21 and 31 which with their one flank portion 22 and 32 pointing in the direction of rotation form in each case the rear wall of a pocket 30 and 20 and with their flank 23 and 33 lying opposite in a circumferential direction form the front wall of a pocket 30 and 20. The pockets 20 are consequently delimited in the circumferential direction by the flank portions 32, 33 of the webs 31 and the pockets 30 by the flank portions 22, 23 of the webs 21. All the webs 21 are in this case formed on the side flank 14 and all the webs 31 are formed on the side flank 13, thus giving rise to the pocket rows lying offset. The contours of the flank portions 22, 23 and 32, 33 of the webs 21 and 31 are adapted essentially to the geometry of the oblique cross of the chain links 11, in order to achieve large-area bearing contact and an advantageous introduction of the circumferential forces into the chain links. Each web 21 or 31 at the same time forms with the surface of its side portion 24 and 34 a side wall for the pockets 30, 20 of the other pocket row. The side portions 24, 34 of the webs 21, 31 between the respective flank portions 22, 23 and 32, 33 in this case extend as essentially planar surfaces which run obliquely with respect to the axis of rotation D and which extend at a constant slope angle of here 45° as far as the base or bottom 25 of the pocket 20 or as far as the bottom 35 of the pocket 30. On the in each case other side flank 13 or 14 lying opposite the web 21 or 31, each pocket 20 is delimited by an opposite wall 26 and each pocket 30 by an opposite wall 36, these opposite walls 26 and 36 also running obliquely at an angle of 45° with respect to the axis of rotation D and extending at this oblique angle as far as the pocket bottom 25 of the pockets 20 or the bottom 35 of the pockets 30.

The side wall 34 and the opposite wall 26 of the pockets 20 consequently stand at right angles to one another and make it possible that a chain link 11 comes to bear with both legs in each case against the side wall 34 or 24 formed by the web 31 or 21, while it comes to bear with the side surface of the legs against the opposite wall 26 or 36. The transition of the obliquely running side wall 34 into the opposite wall 26 or of the opposite wall 36 into the side wall 24 takes place in a transitional channel 37 or 27 with a suitable radius of curvature, in order to achieve a free surface in the region of the V-shaped pocket bottom 25, 35 of each pocket 20, 30.

The webs 31 formed on the flank 13 are arranged in each case in the region of tooth-shaped elevations 15 of the side flank 13, and the webs 21 on the opposite side flank 14 of the sprocket 10 are formed in each case on tooth-shaped elevations 16, between which sinks 17 on the side flank 13 and sinks 18 on the side flank 14 are provided. Each tooth-shaped elevation 15 on the side flank 13 or elevation 16 on the side flank 14 has lying directly opposite it, on the opposite side flank 14 or 13, a sink 18 or 17. In the sprocket 10, the oblique opposite wall 26 or 36 of each pocket 20 or 30 extends from the radial margin of each sink 17, 18. The angular transitions 25 and 35 of the pockets 20 and 30 lie in each case offset with respect to the vertical mid-plane M of the sprocket 10, and, in the sprocket 10 according to FIG. 1, the opposite wall 26 or 36 extends essentially only over half the height of the opposite side wall 34 or 24. What is nevertheless achieved by means of the sinks 18, 17 formed between two tooth-shaped elevations 15, 16 is that fine coal, salt grains, broken rock or the like can be displaced laterally out of the pocket via the top side of the opposite wall 26 when a chain link runs into a pocket 20 or 30 of the sprocket 10. Consequently, the sinks 17, 18, here, therefore, the partial reductions in diameter of the side flanks 13, 14, also form displacement orifices for fine coal and the like.

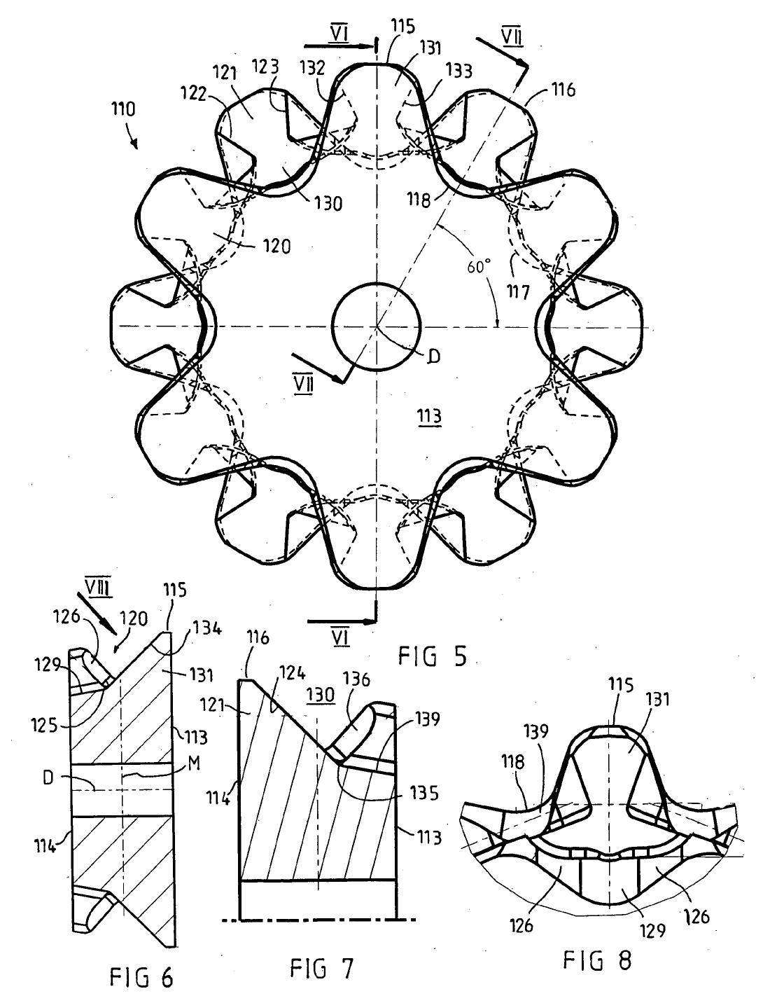

FIGS. 5 to 8 show a second exemplary embodiment of a sprocket 110 according to the invention, identical elements to those in the sprocket according to FIG. 1 to 4 being given here reference symbols increased by 100. The sprocket 110, too, has, distributed over its circumference, pockets 120 and 130 which lie next to and offset with respect to one another and which are designed for the reception and deflection of chain links (not shown) which pass the sprocket 110 in a 45° oblique position with respect to the axis of rotation D. As in the previous exemplary embodiment, overall 12 pockets, to be precise six pockets 120 and six pockets 130, are arranged, distributed over the circumference, and each pocket 130 is delimited in the circumferential direction by the flank portions 122 and 123 of a web 121, while the pockets 120 are delimited in the circumferential direction by the flank portions 132 and 133 of a web 131. All the webs 131 are arranged on the side flank 113 located at the front in FIG. 5, while the webs 121 are arranged on the opposite side flank 113 located at the rear in FIG. 5, and each side flank 113 or 114, in turn, has six tooth-shaped elevations 115 on the side flank 113 and elevations 116 on the side flank 114, on which the webs 121 and 131 are formed. Those side portions 134 of the webs 131 and 124 of the webs 121 which in each case face a pocket 120 and 130 form a side wall of the pocket 120 and 130, which side wall runs obliquely with respect to the axis of rotation D and correspondingly forms a bearing surface, running obliquely with respect to the axis of rotation, for chain links received in the pockets 120 or 130. The obliquely running side wall 124 has a shorter opposite wall 136 lying opposite it, and the obliquely running side wall 134 of the pockets 120 has an obliquely running opposite wall 126 lying opposite it. The opposite wall 126 or 136 and the side wall 134 or 124 lie at right angles to one another and extend as essentially planar surfaces over the longitudinal direction of the pockets 120 and 130 in the circumferential direction.

Contrary to the previous exemplary embodiment, in the sprocket 110 the sinks 117 and 118 extend between two tooth-shaped elevations 115 and 116 as far as the pocket bottom 125 and 135 of the pockets 120 and 130. Consequently, as seen in the circumferential direction, each pocket 120 or 130 has no opposite wall in its middle, but a marginally open recess is provided there by means of the deep-drawn sinks 117 and 118 and forms a particularly large displacement orifice for fine coal, dust accumulations, rock accumulations or the like which could collect inside a pocket 120 or 130. The sinks 117 and 118 are designed in such a way that the pocket 120 runs out from the pocket bottom 125 via discharge slopes 129 to the side flank 114 or via discharge slopes 139 to the side flank 113 of the sprocket 110, so that corresponding accumulations can be driven out of the pockets 120 and 130 outward particularly effectively. The sinks 117, 118 consist here of arcuate transitions of two elevations 115 and 116 one into the other. The deep-drawn sinks 117 and 118 subdivide the opposite wall 126 into two part surfaces, between which the displacement orifice with the discharge slope 129 or 139 is formed, as can be seen particularly clearly from FIG. 8.

In contrast to the previous exemplary embodiments, however, here each opposite wall 226 is provided with an oval long hole 228 oriented in the circumferential direction and closed at the margin, and each opposite wall 236 is provided correspondingly with a long hole 238 on the side flank 213, these long holes 228, 238 forming displacement orifices for rock accumulations, fine coal or the like. The long holes 228, 238 extend, with the exception of a circumferential web 240, 250, over the respective height of the opposite wall 226 or 236 and as far as the bottom 225 or 235 of each pocket. Once again, discharge slopes 229, 239 with a slope angle of about 10° are formed at the base of the long holes 228, 238, in order to assist the displacement of fine coal or the like. As can be gathered particularly clearly from FIG. 12, on account of the long holes 228, 238 each chain link passing the sprocket 210 in an oblique position is supported only partially with its chain oblique crosses in the region of the opposite wall 236, since the long holes 228, 238 at the same time form a free surface in the region of the opposite wall 226 or 236 of each pocket 220, 230.

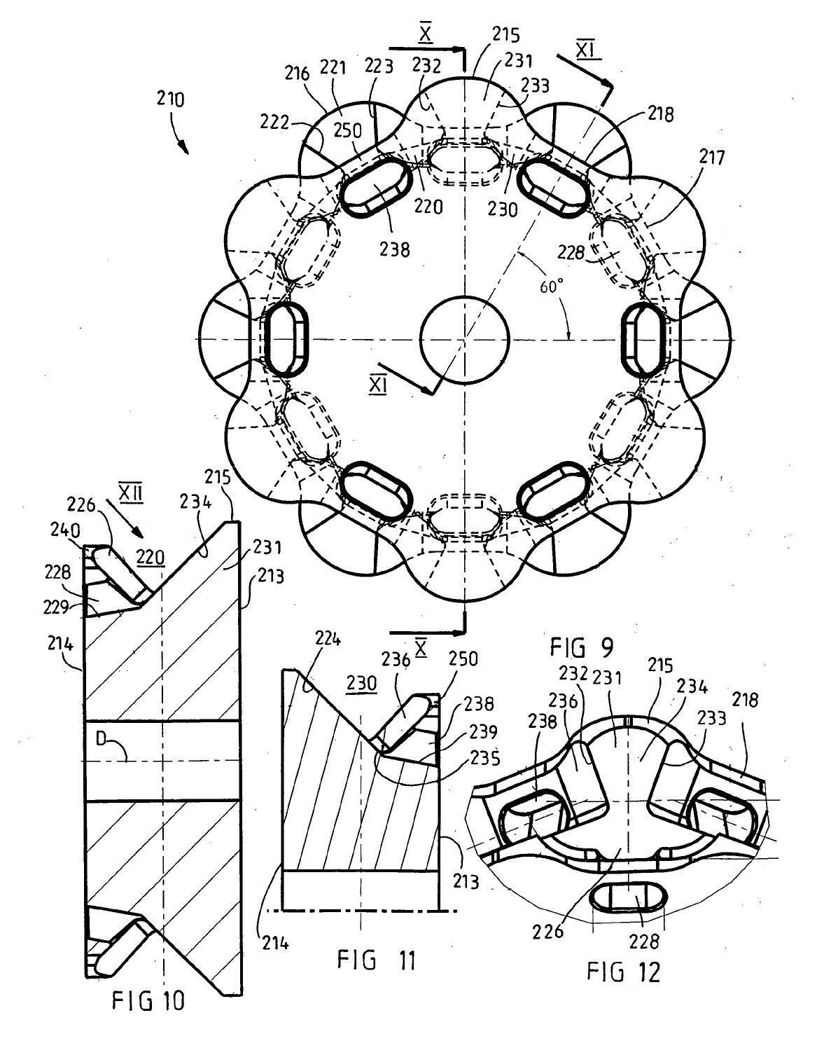

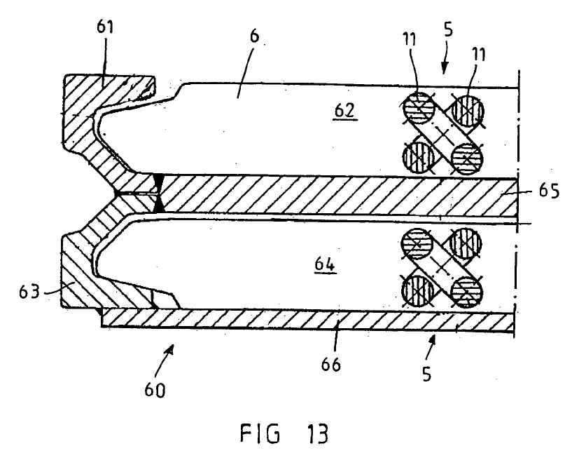

FIG. 13 shows highly diagrammatically, in simplified form, in vertical section one half of a trough section 60 of a scraper chain conveyor, not illustrated in any more detail, in which the drive chain 5 is deflected by means of sprockets, such as are shown in FIGS. 1 to 12. Each trough section 60 of a scraper chain conveyor has in a way known per se side profiles 61 for a conveying strand or upper strand 62 and side profiles 63, arranged so as to be mirror-inverted with respect to these, for a lower strand or return strand 66, in which the scrapers 6 connected to the link chain 5 are guided with their scraper ends. The link chain rotates as an endless chain band between a main drive and auxiliary drive (not illustrated). Since the chain links 11 of the scraper chain 5 lie in each case obliquely at 45° with respect to the horizontal or vertical, the chain links 11 are in each case supported with their lower legs on the conveyor bottom 65 or on the bottom 66 of the lower strand in two zones, so that the wear of the conveyor bottom 65 and of the lower strand 66 on account of the necessarily occurring frictional forces is lower than in the prior art. At the same time, because of the oblique arrangement of the chain links 11 of the scraper chain 5, the overall height can be minimized, with the same chain thickness being maintained, since a lower minimum overall height of each strand 62, 64 of the scraper chain conveyor 60 is permitted. A further advantage in using a scraper chain 5 with obliquely lying chain links 11 in a scraper chain conveyor 60 arises in that each chain link 11 rotates in the sprockets 10, 110 and 210 as a carrying chain link and is loaded with the circumferential forces, so that the loads caused on the individual chain links during deflection at the sprocket decrease considerably, as compared with the conventional chain routing with vertical and horizontal chain links in which only every second chain link can form a carrying chain link.

Further, while considerable emphasis has been placed on the preferred embodiments of the invention illustrated and described herein, it will be appreciated that other embodiments, and equivalences thereof, can be made and that many changes can be made in the preferred embodiments without departing from the principles of the invention. Furthermore, the embodiments described above can be combined to form yet other embodiments of the invention of this application. Accordingly, it is to be distinctly understood that the foregoing descriptive matter is to be interpreted merely as illustrative of the invention and not as a limitation.

1-21. (canceled)

22. A sprocket for chain drives including:
an axis of rotation;
two groups of pockets for chain links passing the sprocket in an oblique position in relation to said axis of rotation and are arranged next to and offset with respect to one another on the circumference of the sprocket, wherein each pocket is delimited laterally by a side wall and an opposite wall and, in the circumferential direction, by webs, which form with flank portions, a front wall and rear wall of the pockets of one group for the transmission of forces to a chain link rotating in the pocket and which form with a side portion the side wall of the pockets of the other group, wherein the side wall and the opposite wall of a pocket form bearing surfaces which run obliquely with respect to the axis of rotation and which extend as far as a bottom portion of the pockets.

23. A sprocket as claimed in claim 22, wherein a bearing surface is formed on the side portion of the webs as a planar surface extending as far as the bottom portion of the pocket.

24. A sprocket as claimed in claim 22, wherein the bottom portion of the pocket consists of an angular transition of the side wall into the opposite wall.

25. A sprocket as claimed in one of claim 24, wherein the bottom portion is provided with a preferably rounded longitudinal channel.

26. A sprocket as in claim 25, characterized in that the one of said transitions and said longitudinal channels of one group of pockets and those of the other group of pockets lie offset with respect to a mid-plane of the sprocket.

27. A sprocket as claimed in claim 23, wherein the bearing surface on the side wall and the bearing surface on the opposite wall stand at right angles to one another.

28. A sprocket as claimed in claim 23, characterized in that the bearing surfaces run at an inclination of 45° with respect to the axis of rotation.

29. A sprocket as claimed in one of claim 22, further consisting of a one-part blank with pockets that are at least one of milled-out and finish-machined by the grinding method.

30. A sprocket as claimed in claim 22, further comprising two side flanks, each side flank being provided with a number of webs which correspond to the number of pockets, and an opposite wall being formed between two webs of a side flank.

31. A sprocket as claimed in claim 30, wherein said web includes a bearing surface on the web, the bearing surface of the opposite wall has a lower height than the bearing surface on the web.

32. A sprocket of claims 22, wherein each opposite wall is provided with a displacement orifice for fine coal or the like.

33. A sprocket as in claim 32, wherein the displacement orifice consists of a passage in the opposite wall.

34. A sprocket as in claim 22, wherein the webs are formed on tooth-shaped elevations on the two side flanks of said sprocket and between said elevations are sinks which at least partially form displacement orifices for fine coal or the like.

35. A sprocket as in claim 34, wherein the sinks extend, at least in the middle of the pockets, as far as the pocket bottom.

36. A sprocket as in claim 34, wherein the sinks extend over a portion of the height of the pockets, forming passages for fine coal or the like between the circumferential web of the sinks and the bottom portion of the pockets.

37. The sprocket as in claim 36, characterized in that the side flanks are provided with discharge slopes in the region of at least one of the passages and the sinks extending to a great depth.

38. The sprocket as in claim 36, characterized in that the passages consist of long holes.

39. The sprocket as in claim 30, characterized in that each side flank is provided with six elevations and one or more sinks which are spaced apart at 60° from one another.

40. A sprocket as in claims 22, wherein said sprocket is adapted for use as at least one of a driving and deflecting sprocket for a planning chain of a mining plane, and a scraper chain of a scraper chain conveyor, in particular for mineral extraction, coal extraction or mining.

41. A sprocket for chain drives including,
an axis of rotation,
at least two groups of pockets for chain links passing the sprocket in an oblique position relative to said axis of rotation, said pockets including a side wall and an opposite wall and, in the circumferential direction, by webs forming a front wall and a rear wall of at least one pocket group, wherein said webs are formed on tooth-shaped elevations on two side flanks, wherein between said elevations are sinks, which at least partially form displacement orifices for fine coal or the like.

42. A sprocket comprising:
an axis of rotation;
a first and second side flank arranged next to one another, each side flank comprising tooth shaped elevations and sinks disposed between said elevations, said first side flank having a first group of pockets and said second side flank having a second group of pockets, said pockets being distributed at uniform angular intervals around the circumference of said flank; and
a plurality of webs formed on said tooth-shaped elevations of said side flanks, each web including a first flank portion pointing in the direction of rotation and a second flank portion pointing in a circumferentially opposite direction, each web including a side wall,
wherein said pockets are delimited in a circumferential direction by said first and second flank portions, and delimited in the lateral direction by said side wall and an opposite wall formed in said side flank opposite said web.
